(19) United States
(12) Patent Application Publication
(10) Pub. No.: US 2026/0300916 A1
(43) Pub. Date: Oct. 1, 2026

(54) FULFILLMENT PLANNER

(71) Applicant: DoorDash, Inc., San Francisco, CA (US)

(72) Inventors: Amrik Kochhar, San Francisco, CA (US); Kapil Deshpande, Seattle, WA (US); Fan Peng, Pittsburgh, PA (US); Abhishek Sharma, Issaquah, WA (US); Anirvana Mishra, Seattle, WA (US)

(73) Assignee: DoorDash, Inc., San Francisco, CA (US)

(21) Appl. No.: 19/576,576

(22) Filed: Mar. 24, 2026

Related U.S. Application Data
(60) Provisional application No. 63/777,277, filed on Mar. 25, 2025.

(51) Int. Cl. G06Q 10/087

(52) U.S. Cl. CPC G06Q 10/0877

(57) ABSTRACT

A method includes receiving, from an end user device, an order for one or more items, wherein the one or more items are available from a plurality of service providers at a plurality of service provider locations. The method also includes determining a set of candidate service providers from the plurality of service providers. Each candidate service provider is within a predetermined distance of a user location associated with the order. Also, for each candidate service provider in the set of candidate service providers, the method includes determining, using at least one machine learning model, a probability of availability for the one or more items at the respective service provider location. The method includes formulating a fulfillment plan by selecting one or more service providers from the set of candidate service providers based at least in part on the determined probabilities of availability, and executing the fulfillment plan.

### CROSS-REFERENCES TO RELATED APPLICATIONS

This application is a non-provisional application of U.S. Provisional Application No. 63/777,277, filed on Mar. 25, 2025, which is herein incorporated by reference in its entirety for all purposes.

### BRIEF SUMMARY

One embodiment includes a method comprising receiving, from an end user device, an order for one or more items, wherein the one or more items are available from a plurality of service providers at a plurality of service provider locations; determining a set of candidate service providers from the plurality of service providers, wherein each candidate service provider is within a predetermined distance of a user location associated with the order; for each candidate service provider in the set of candidate service providers, determining, using at least one machine learning model, a probability of availability for the one or more items at the respective service provider location; formulating a fulfillment plan by selecting one or more service providers from the set of candidate service providers based at least in part on the determined probabilities of availability; and executing the fulfillment plan.

Another embodiment of the invention is directed to a central server computer comprising: a processor; and a computer readable medium coupled to the processor, the computer readable medium comprising code, executable by the processor to perform a method comprising: receiving, from an end user device, an order for one or more items, wherein the one or more items are available from a plurality of service providers at a plurality of service provider locations; determining a set of candidate service providers from the plurality of service providers, wherein each candidate service provider is within a predetermined distance of a user location associated with the order; for each candidate service provider in the set of candidate service providers, determining, using at least one machine learning model, a probability of availability for the one or more items at the respective service provider location; formulating a fulfillment plan by selecting one or more service providers from the set of candidate service providers based at least in part on the determined probabilities of availability; and executing the fulfillment plan.

These and other embodiments are described in further detail below.

### BRIEF DESCRIPTION OF THE DRAWINGS

FIG. 1 shows a block diagram of an item fulfillment system.

FIG. 2 shows a block diagram of a central server computer.

FIG. 3 illustrates different item fulfillment plans for an example order.

FIG. 4 shows a diagram of a fulfillment planner and its interaction with various data.

FIG. 5 illustrates a flow diagram of a method for generating fulfillment plans.

FIG. 6 illustrates a flow diagram of a scenario where an end user created a cart but has not yet placed an order and is allowed to selected from alternate stores.

FIG. 7 illustrates a flow diagram of a scenario where an end user has placed an order but the order has not yet been presented to a transporter.

FIG. 8 shows a screenshot of a graphical user interface of that a user may view in embodiments of the invention.

### DETAILED DESCRIPTION

Prior to discussing embodiments of the disclosure, some terms can be described in further detail.

An “item” can be an individual article or unit. Examples of items can include perishable items such as food items, beauty items (e.g., cosmetics), office supply products (e.g., staples, paper, and ink), hardware items (e.g., nails, hammers, wrenches), electronic devices (e.g., computers, phones, etc.), jewelry, etc.

A “user” may include an individual or a computational device. In some embodiments, a user may be associated with one or more personal accounts and/or mobile devices. In some embodiments, the user may be a consumer or a customer.

A “user device” may be a device that is operated by a user. In some embodiments, the user device can be an electronic device that can process information and communicate with other electronic devices. A user device may include a processor and a computer-readable medium coupled to the processor, the computer-readable medium comprising code, executable by the processor. Examples of user devices may include a mobile device, a laptop or desktop computer, a wearable device, etc.

A “transporter” can be an entity that transports something. A transporter can be a person that transports an item using a transportation device (e.g., a car). In other embodiments, a transporter can be a transportation device that may or may not be operated by a human. Examples of transportation devices include cars, boats, scooters, bicycles, drones, airplanes, etc. In some embodiments, the transporter user device can be integrated into a transportation device.

A “fulfillment request” can be a request to provide a resource in response to a request. For example, a fulfillment request can include an initial communication from an end user device to a central server computer for a first service provider computer to fulfill a purchase request for a resource such as food. A fulfillment request can be in an initial state, a completed state, or a final state. A fulfillment request can include one or more selected items that a user wishes to obtain from a selected service provider.

A “service provider” may be an entity, such as a merchant or retailer, which makes one or more items available for acquisition by a user. While a service provider can be a restaurant, the term also encompasses a wide range of other commercial establishments that offer goods for sale or fulfillment. Examples of a service provider can include, but are not limited to, a grocery store, a convenience store, a pharmacy, a retail store selling consumer packaged goods, or a fulfillment center. In some embodiments, a service provider operates at one or more physical “service provider locations” and may utilize a “service provider computer” to communicate with a central server computer, for example, to receive order information for preparation and pickup by a transporter.

A “delivery order” can include a request to deliver one or more items. Delivery orders can include requests to provide one or more items from a pickup location to a drop-off location. Delivery orders can include orders to deliver items from service provider locations to end user locations. Delivery orders can include orders to deliver items from end user locations to service provider locations. An example of this type of delivery order can be a return order (e.g., to deliver an item that is to be returned). A delivery order can include data to fulfill the delivery request including an order type, an indication of an item, a pickup location, and a drop-off location. In some embodiments, the delivery order can include a scheduling range by which the order is to be fulfilled. A delivery order can also include metadata. The metadata can include data relating to the delivery order (e.g., related order numbers, instruction data, etc.).

A “route” can include a way or course taken in getting from a starting point to a destination. For example, a route can indicate a path that can be followed to move from a pickup location to a drop-off location. In some embodiments, a route can indicate a suggested path that a transporter can follow to deliver an item from a service provider to an end user (or vice-versa) for a delivery order. In some embodiments, a route can be referred to as a journey. In some embodiments, a central server computer can route and automatically control (e.g., using a route map and control signals) an autonomous vehicle according to pick up an item from a service provider and deliver it to an end user.

A “query” can include a request for information. A query can include an instruction provided by a user or a user device to a computer system. In some embodiments, a query may comprise textual, voice, or structured data input that expresses the user's intent to search, retrieve, or interact with information. A query may include keywords, phrases, questions, or commands, and may be accompanied by metadata such as user information, device type, location, or historical context. The query may be processed by computational models or algorithms to generate responses, retrieve documents, or perform actions relevant to the user's intent.

A “machine learning computer” can include a device that creates, trains, and/or otherwise manipulates models. A machine learning computer can train a machine learning model.

A “machine learning model” (ML model) can include a software module configured to be run on one or more processors to provide a classification or numerical value of a property of one or more samples. An ML model can include various parameters (e.g., for coefficients, weights, thresholds, functional properties of function, such as activation functions). As examples, an ML model can include at least 10, 100, 1,000, 5,000, 10,000, 50,000, 100,000, or one million parameters. An ML model can be generated using sample data (e.g., training samples) to make predictions on test data. Various number of training samples can be used, e.g., at least 10, 100, 1,000, 5,000, 10,000, 50,000, 100,000, or at least 200,000 training samples. One example is an unsupervised learning model such as hidden Markov model (HMM), clustering (e.g., hierarchical clustering, k-means, mixture models, model-based clustering, density-based spatial clustering of applications with noise (DBSCAN), and OPTICS algorithm), approaches for learning latent variable models such as Expectation-maximization algorithm (EM), method of moments, and blind signal separation techniques (e.g., principal component analysis, independent component analysis, non-negative matrix factorization, singular value decomposition), and anomaly detection (e.g., local outlier factor and isolation forest). Another example type of model is supervised learning that can be used with embodiments of the present disclosure. Example supervised learning models may include different approaches and algorithms including analytical learning, statistical models, artificial neural network (e.g. including convolutional and/or transformer layers) that may have 1-10 layers as examples, recurrent neural network (e.g., long short term memory, LSTM), boosting (meta-algorithm), bootstrap aggregating (bagging) such as random forests, support vector machine (SVM), support vector (SVR), Bayesian statistics, case-based reasoning, decision tree learning, inductive logic programming, linear regression, logistic regression, Gaussian process regression, genetic programming, group method of data handling, kernel estimators, learning automata, learning classifier systems, minimum message length (decision trees, decision graphs, etc.), multilinear subspace learning, naive Bayes classifier, maximum entropy classifier, conditional random field, nearest neighbor algorithm, probably approximately correct learning (PAC) learning, ripple down rules, a knowledge acquisition methodology, symbolic machine learning algorithms, subsymbolic machine learning algorithms, minimum complexity machines (MCM), ordinal classification, data pre-processing, handling imbalanced datasets, statistical relational learning, or Proaftn (a multicriteria classification algorithm), or an ensemble of any of these types. Supervised learning models can be trained in various ways using various cost/loss functions that define the error from the known label (e.g., least squares and absolute difference from known classification) and various optimization techniques, e.g., using backpropagation, steepest descent, conjugate gradient, and Newton and quasi-Newton techniques.

A “deep neural network (DNN)” may be a neural network in which there are multiple layers between an input and an output. Each layer of the deep neural network may represent a mathematical manipulation used to turn the input into the output. In particular, a “recurrent neural network (RNN)” may be a deep neural network in which data can move forward and backward between layers of the neural network.

An “encoder” can process an input sequence to create a vector. Encoders can process input sequences to generate embedding vectors. An encoder can encode data from a higher dimensionality to a lower dimensionality. A “decoder” can process a vector to create an output sequence. Decoders can process embedding vectors, or vectors modified therefrom, to generate an output sequence. A decoder can decode data from a lower dimensionality to a higher dimensionality. Both encoders and decoders can be separate, fully connected neural networks. Encoders and decoders may be recurrent neural networks (RNNs) or variants thereof (e.g., long-short term memory (LSTM), gated recurrent units (GRUs), etc.) and convolutional neural networks (CNNs), as well as transformer models. An encoder-decoder model can include several encoders and several decoders.

A “model database” may include a database that can store machine learning models. Machine learning models can be stored in a model database in a variety of forms, such as collections of parameters or other values defining the machine learning model. Models in a model database may be stored in association with keywords that communicate some aspect of the model. For example, a model used to evaluate news articles may be stored in a model database in association with the keywords “news,” “propaganda,” and “information.” A machine learning computer can access a model database and retrieve models from the model database, modify models in the model database, delete models from the model database, or add new models to the model database.

A “feature vector” may include a set of measurable properties (or “features”) that represent some object or entity. A feature vector can include collections of data represented digitally in an array or vector structure. A feature vector can also include collections of data that can be represented as a mathematical vector, on which vector operations such as the scalar product can be performed. A feature vector can be determined or generated from input data. A feature vector can be used as the input to a machine learning model, such that the machine learning model produces some output or classification. The construction of a feature vector can be accomplished in a variety of ways, based on the nature of the input data. For example, for a machine learning classifier that classifies words as correctly spelled or incorrectly spelled, a feature vector corresponding to a word such as “LOVE” could be represented as the vector (12, 15, 22, 5), corresponding to the alphabetical index of each letter in the input data word. For a more complex “input,” such as a human entity, an exemplary feature vector could include features such as the human's age, height, weight, a quantitative representation of relative happiness, etc. Feature vectors can be represented and stored electronically in a feature store. Further, a feature vector can be normalized (i.e., be made to have unit magnitude). As an example, the feature vector (12, 15, 22, 5) corresponding to “LOVE” could be normalized to approximately (0.40, 0.51, 0.74, 0.17).

A “language model” can include a computational model trained on natural language datasets. A language model can include a large language model (LLM). A language model can be configured to generate, interpret, or analyze language. A language model may comprise a neural network architecture, such as a transformer-based model, having hundreds of millions or more parameters. A language model may be trained using supervised, unsupervised, or self-supervised learning techniques, and may be capable of performing tasks including natural language understanding, text generation, translation, summarization, question answering, and semantic search.

An “embedding” can include numerical representations. An embedding can include a vector. An embedding can be a lower-dimensional vector that is derived from complex high-dimensional data.

A “processor” may include a device that processes something. In some embodiments, a processor can include any suitable data computation device or devices. A processor may comprise one or more microprocessors working together to accomplish a desired function. The processor may include a CPU comprising at least one high-speed data processor adequate to execute program components for executing user and/or system-generated requests. The CPU may be a microprocessor such as AMD's Athlon, Duron, and/or Opteron; IBM and/or Motorola's PowerPC; IBM's and Sony's Cell processor; Intel's Celeron, Itanium, Pentium, Xeon, and/or XScale; and/or the like processor(s).

A “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may comprise one or more computational apparatuses and may use any of a variety of computing structures, arrangements, and compilations for servicing the requests from one or more client computers.

Current methods for determining a fulfillment plan include matching transporters to deliveries, but do not optimize at the item or the store level. This may be sufficient for restaurant deliveries, where end users care about receiving restaurant specific items. In this case, item level optimization is not necessary. Additionally, for restaurant deliveries, the end user often selects the restaurant so store level optimization is not as important. Still further, if there are restaurants that can provide the same item (e.g., more than one restaurant that can sell a hamburger), then the closest restaurant is usually the best choice because item quality is tied to delivery speed.

However, in other scenarios, the fulfillment rate (e.g., whether or not the requested item is delivered) may be more important than speed, so the closest store is not necessarily the best option if the item is not in stock. For example, an end user requesting paper towels (or other less perishable items such as grocery, retail, or alcohol items) may care less about the store from which the end user is purchasing and the delivery speed than whether they receive the item. Including item level and store level consideration can improve such item fulfillments.

Yet, optimization across service providers, items, and available transporters can create a complex, high cardinality optimization problem which can be computationally expensive and slow.

Embodiments of the invention are directed towards methods and systems for creating fulfillment plans for delivering items to end users. A central server can generate a fulfillment plan to present to one or more transporters to retrieve items from one or more service provider locations and deliver them to an end user. The central server computer can aggregate data and various fulfillment signals to select the best service provider location or set of service provider locations and the best transporter or set of transporters for item fulfillment. Advantageously, the service provider is optimized before transporter presentment, which is less computationally expensive than optimizing across service providers, items, and available transporters.

Embodiments can evaluate cost and quality at the item level to optimize fulfillment plans and increase fulfillment rates. Embodiments can also enable the dynamic selection of the service provider(s). For example, embodiments of the invention can provide a fulfillment plan comprising one or more service providers for providing the requested items, even if the one or more service providers are different from the checkout store (e.g., where the end user placed the order). If there is a high probability that a requested item is out of stock (e.g., the service provider that the end user placed an order with), embodiments can switch to another service provider or set of service providers that have all requested items in stock.

Stated differently, embodiments of the invention include a server-based system and method for generating and executing an optimized fulfillment plan for an order containing one or more items. The system addresses the technical problem of inefficient and low-quality fulfillment in traditional systems, which typically anchor an order to a single, predetermined service provider (e.g., a store) selected by the end user. This legacy approach is particularly ineffective for retail and grocery orders where item availability, fulfillment cost, and overall quality are more important to the end user than loyalty to a specific store location, often resulting in order cancellations and a poor user experience.

Embodiments of the invention solves this problem through a novel fulfillment planner system that intelligently and dynamically determines the optimal fulfillment strategy for an order. A technical innovation is the architectural decoupling of the end user's order from the physical fulfillment process. The system bifurcates the traditional order model into a “customer order,” representing the end user's unified intent and payment, and one or more “merchant orders,” which represent the discrete fulfillment tasks transmitted to service providers. This establishes a one-to-many relationship, enabling a single end user order to be split and sourced from multiple service providers or fulfilled using different transmission protocols to ensure completeness and quality.

Furthermore, the system overcomes the computational complexity of simultaneously optimizing for items, service providers, and transporters by employing a two-phase optimization strategy. First, the fulfillment planner determines an optimal store or set of stores for sourcing the items. Second, this finalized fulfillment plan is handed off to a logistics platform to solve the less complex problem of presenting the delivery to a transporter for execution. This separation of concerns significantly reduces the cardinality of the optimization problem, enabling more efficient and timely plan generation.

In operation, the fulfillment planner comprises at least two components: an orchestrator and an optimizer. The orchestrator can be an event-driven module that monitors the entire lifecycle of an order, responding to triggers such as order creation, cart updates, fulfillment failures (e.g., a store closure or an out-of-stock signal), and/or scheduled timers. Upon such a trigger, the orchestrator can initiate the optimizer to compute and rank potential fulfillment plans. The optimizer can execute a multi-step algorithm wherein it first identifies a set of candidate service providers within a predetermined distance of the end user. For each candidate service provider, it then utilizes one or more machine learning models to determine the probability that the requested items are physically present and in stock. The algorithm proceeds to calculate other signals, including fulfillment costs, the probability of batching the order with other deliveries to improve efficiency, and an overall quality score for the service provider. These signals can be synthesized to generate a ranked list of fulfillment plans, with the top-ranked plan being selected for execution.

This system according to embodiments of the invention enables several advanced fulfillment capabilities. It can proactively present an end user with an offer to switch to a different service provider pre-checkout if it detects a high risk of an item being out of stock. It can also dynamically adjust the fulfillment plan post-checkout to optimize for cost or quality based on real-time network conditions. In the event of a fulfillment failure, the system can automatically and seamlessly re-route the order to an alternate service provider without requiring end-user intervention or the creation of a confusing new order. The architecture also provides the foundation for “virtual stores,” where a user can shop from the aggregated inventor of multiple physical locations via a virtual store interface, with the system determining the optimal sourcing strategy after the order is placed.

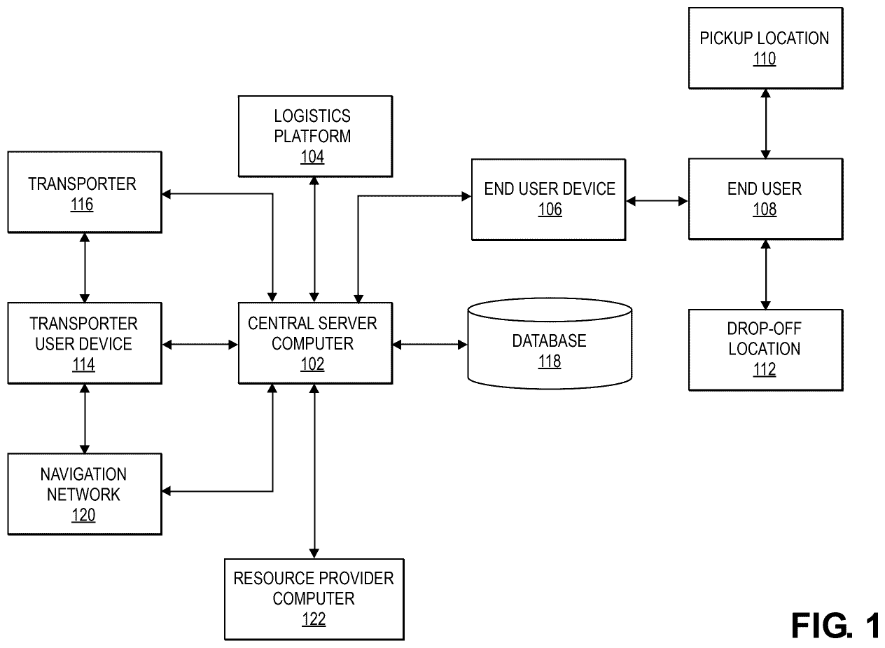

FIG. 1 shows a system 100 according to embodiments of the disclosure. The system of FIG. 1 includes a central server computer 102, a logistics platform 104, an end user device 106, an end user 108, a pickup location 110, a drop-off location 112, a transporter user device 114, a transporter 116, a navigation network 120, a service provider computer 122, and a database 118.

The central server computer 102 can be in operative communication with the logistics platform 104, the end user device 106, the transporter user device 114, the navigation network 120, the service provider computer 122, and the database 118. The transporter user device 114 can be in operative communication with the navigation network 120.

For simplicity of illustration, a certain number of components are shown in FIG. 1. It is understood, however, that embodiments of the invention may include more than one of each component. In addition, some embodiments of the invention may include fewer than or greater than all of the components shown in FIG. 1A. For example, although FIG. 1 shows a transporter 116, there can be two, three, or more transporters, transporter user devices, etc. present in the system 100.

Messages between the devices and the computers in the system 100 in FIG. 1 can be transmitted using a secure communications protocols such as, but not limited to, File Transfer Protocol (FTP); HyperText Transfer Protocol (HTTP); Secure Hypertext Transfer Protocol (HTTPS), SSL, ISO (e.g., ISO 8583), and/or the like. The communications network may include any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. The communications network can use any suitable communications protocol to generate one or more secure communication channels. A communications channel may, in some instances, comprise a secure communication channel, which may be established in any known manner, such as through the use of mutual authentication and a session key, and establishment of a Secure Socket Layer (SSL) session.

The central server computer 102 can include a server computer that can facilitate in the fulfillment of fulfillment requests received from the end user device 106. For example, the central server computer 102 can identify the transporter 116 (from among many candidate transporters) operating the transporter user device 114 as being suitable for satisfying the fulfillment request. The central server computer 102 can identify the transporter user device 114 that can satisfy the fulfillment request based on any suitable criteria (e.g., transporter location, service provider location, end user destination, end user location, transporter mode of transportation, etc.).

The central server computer 102 can receive data relating to a delivery order of items from the service provider computer 122 to the end user 108 at the drop-off location 112. The central server computer 102 can determine a route for delivery of the delivery order. The central server computer 102 can present the routes to a plurality of transporter user devices and/or transporters. The central server computer 102 can receive acceptances from the transporter 116 that will deliver the items from the pickup location 110 to the drop-off location 112.

The central server computer 102 can receive a query from the end user device 106. The central server computer 102 can determine one or more documents based on the query. The central server computer 102 can provide the one or more documents to the end user device 106.

The logistics platform 104 can include a location determination system, which can determine the locations of various user devices such as transporter user devices (e.g., the transporter user device 114) and end user devices (e.g., the end user device 106). The logistics platform 104 can also include routing logic to efficiently route transporters using the transport user devices to various pickup locations that have the packages that are to be delivered to drop-off locations. Efficient routes can be determined based on the locations of the transporters, the locations of the pickup locations, the locations of the drop-off locations, as well as external data such as traffic patterns, the weather, etc. The logistics platform 104 can be part of the central server computer 102 or can be system that is separate from the central server computer 102.

The end user device 106 can include a device operated by the end user 108. The end user devices 106 can generate and provide fulfillment request messages to the central server computer 102. The fulfillment request message can indicate that the request (e.g., a request for a service) can be fulfilled by the service provider computer 122. For example, the fulfillment request message can be generated based on a cart selected at checkout during a transaction using a central server computer application installed on the end user device 106. The fulfillment request message can include one or more items from the selected cart.

The end user device 106 can provide a fulfillment request message to the central server computer 102 that indicates that the end user device 106 is requesting that the transporter 116 pick up an item from the pickup location 110 (e.g., end user's 108 location) and deliver the item to the drop-off location 112 (e.g., the service provider computer's 122 location).

The pickup location 110 can be a location in which items are stored. In the context of an outbound delivery from an end user at an end user location, examples of the pickup location 110 may be a house or an apartment, a mailbox, a service provider location (e.g., a retail store, a grocery store, a dry cleaning store), a pickup hub, etc. Items can first be obtained from a pickup location 110 and then be transported to the drop-off location 112. Examples of the drop-off location 112 can be similar to the pickup location 110, such a house or apartment, a mailbox, a retail store, a grocery store, a dry cleaning store, a pickup hub, etc. In one example, the pickup location 110 can be a pizza parlor from which the end user 108 orders a pizza. The drop-off location 112 can be an apartment in which the end user 108 resides.

The transporter user device 114 can include a device operated by the transporter 116. The transporter user device 114 can include a smartphone, a wearable device, a personal assistant device, etc. The transporter 116 can accept an end user's fulfillment request via an acceptance message. For example, the transporter user device 114 can generate and transmit a request to fulfil a particular end user's fulfillment request to the central server computer 102. The central server computer 102 can notify the transporter user device 114 of the fulfillment request. The transporter user device 114 can respond to the central server computer 102 with a request to perform the delivery to the end user as indicated by the fulfillment request.

In some embodiments, the transporter 116 can be an operator of a vehicle. In other embodiments, the transporter 116 can be a vehicle that can operated by an operator or can be autonomous. The vehicle can include a car, a truck, a van, a motorcycle, a bicycle, a drone, or other vehicle.

The navigation network 120 can provide navigational directions to the transporter user device 114 via the central server computer 102. For example, the transporter user device 114 can obtain a location from the central server computer 102. The location can be a service provider parking location, a service provider location, an end user parking location, an end user location, etc. The navigation network 120 can provide navigational data to the location. For example, the navigation network 120 can be a global positioning system that provides location data to the transporter user device 114. If the transporter is an autonomous vehicle that includes the transporter user device 114, the transporter user device 114 can receive control signals from the central server computer 102 to cause the autonomous vehicle to travel according to one or more service provider locations to fulfill a fulfillment plan.

The service provider computer 122 can be operated by a service provider. For example, the service provider computer 122 can be a retail merchant selling goods for sale. The service provider computer 122 can offer to provide services to the end user 108 of the end user device 106. In embodiments of the invention, the service provider computer 122 can receive requests to prepare or obtain one or more items for delivery from the central server computer 102. The service provider computer 122 can initiate the preparation or collection of the one or more items that are to be delivered to the end user 108 of the end user device 106 by the transporter 116 of the transporter user device 114.

The database 118 can include any suitable database. The database may be a conventional, fault tolerant, relational, scalable, secure database such as those commercially available from Oracle™ or Sybase™. The database 118 can store data related to fulfillment requests.

The central server computer 102 can determine fulfillment plans comprising how orders will be fulfilled. The fulfillment plans can include end user preferences and delivery window constraints, the requested items, a set of service provider locations to source the requested items, and other constraints for the order (e.g., personal shopper request).

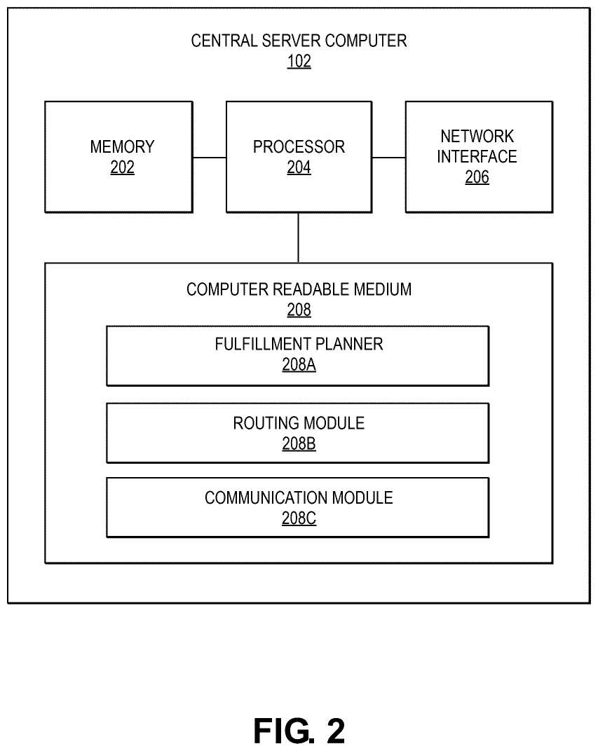

FIG. 2 shows a block diagram of a central server computer 102 according to embodiments. The exemplary central server computer 102 may comprise a processor 204. The processor 204 may be coupled to a memory 202, a network interface 206, and a computer readable medium 208. The computer readable medium 208 can comprise a fulfillment planner 208A, a routing module 208B, and a communication module 208C.

The memory 202 can be used to store data and code. For example, the memory 202 can store documents, queries, fulfillment data, etc. The memory 202 may be coupled to the processor 204 internally or externally (e.g., cloud based data storage), and may comprise any combination of volatile and/or non-volatile memory, such as RAM, DRAM, ROM, flash, or any other suitable memory device. The memory 202 may also comprise one or more databases of information which can be used to facilitate deliveries as described herein.

The computer readable medium 208 may comprise code, executable by the processor 204, for performing a method comprising: receiving, from an end user device, an order for one or more items, wherein the one or more items are available from a plurality of service providers at a plurality of service provider locations; determining a set of candidate service providers from the plurality of service providers, wherein each candidate service provider is within a predetermined distance of a user location associated with the order; for each candidate service provider in the set of candidate service providers, determining, using at least one machine learning model, a probability of availability for the one or more items at the respective service provider location; formulating a fulfillment plan by selecting one or more service providers from the set of candidate service providers based at least in part on the determined probabilities of availability; and executing the fulfillment plan.

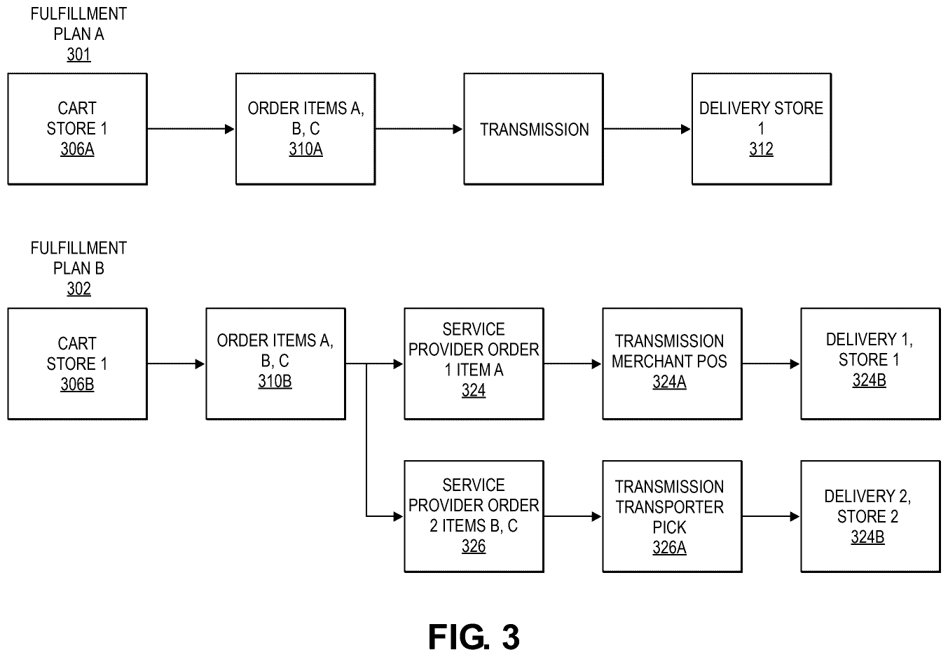

The fulfillment planner 208A may determine fulfillment plans. Further aspects of the fulfillment planner 208A can be found in the description of FIG. 3 below.

The routing module 208B may route transporters delivering items to end users. The routing module 208B can generate display and/or control data which can be transmitted to transporter user devices and/or the transporters. Such data may be used to facilitate the delivery of items from service providers to end users.

The communication module 208C may facilitate communication among entities. The communication module 208C can include code for causing the central server computer to receive and transmit messages to various external devices such as end user devices, transporter user devices, etc.

The network interface 206 may include an interface that can allow the central server computer 102 to communicate with external computers. The network interface 206 may enable the central server computer 102 to communicate data to and from another device (e.g., the logistics platform 104, the end user device 106, the transporter user device 114, the transporter 116, the database 118, the navigation network 120, the service provider computer 122, etc.). Some examples of the network interface 206 may include a modem, a physical network interface (such as an Ethernet card or other Network Interface Card (NIC)), a virtual network interface, a communications port, a Personal Computer Memory Card International Association (PCMCIA) slot and card, or the like. The wireless protocols enabled by the network interface 206 may include Wi-Fi™. Data transferred via the network interface 206 may be in the form of signals which may be electrical, electromagnetic, optical, or any other signal capable of being received by the external communications interface (collectively referred to as “electronic signals” or “electronic messages”). These electronic messages that may comprise data or instructions may be provided between the network interface 206 and other devices via a communications path or channel. As noted above, any suitable communication path or channel may be used such as, for instance, a wire or cable, fiber optics, a telephone line, a cellular link, a radio frequency (RF) link, a WAN or LAN network, the Internet, or any other suitable medium.

FIG. 3 illustrates a diagram of item fulfillment plans for an order. FIG. 3 shows two fulfillment plans, fulfillment plan A 301 and fulfillment plan B 302, for the orders 310A and 310B. Both orders 310A and 310B include items A, B, and C.

Fulfillment plan A 301 couples the end user's order to the delivery. In the fulfillment plan A 301, the cart (store 1) 306A and the service provider (e.g., delivery store 1) 312 of an item fulfillment request are in a one to one relationship. That is, one service provider (e.g., delivery store 1) 312 is provided for one order 310A. Each of the items from the order 310A are to be fulfilled using the single delivery from a single service provider 312 (e.g., delivery store 1). The end user order 310A (e.g., what the customer has ordered) is the same as what is transmitted to the service provider 312 (e.g., delivery store 1).

Fulfillment plan B 302 decouples the end user's order from the delivery. The fulfillment plan B 302 can enable multiple service providers and multiple deliveries for the cart (store 1) 306B and the order 310B. It splits an order 310B across physical stores and different fulfillment providers. Executing this fulfillment plan may comprise creating a single end user order representing the end user's intent, and creating one or more service provider orders based on the fulfillment plan.

In fulfillment plan B 302, the end user's order may vary from what is transmitted to the service provider (e.g., the service provider order). The order 310B submitted by the end user can be split into two service provider order 1 item A 324 and order 2 items B, C 326 with different transmission protocols: transmission merchant POS 324A and transmission transporter pick 326A. The service provider order 1 item A 324 may be transmitted to a first service provider for the item A, and the service provider order 2 items B, C 326 may be transmitted to a second service provider for the items B and C. In an embodiment where the fulfillment plan selects two service providers, a first service provider order entity may be transmitted to the first service provider and a second service provider order may be transmitted to the second service provider. Additionally, delivery 1 (store 1) 324B can deliver item A and delivery 2 (store 2) 326B can deliver items B and C to the end user. Delivery 324B and 326B may be serviced by different transporters.

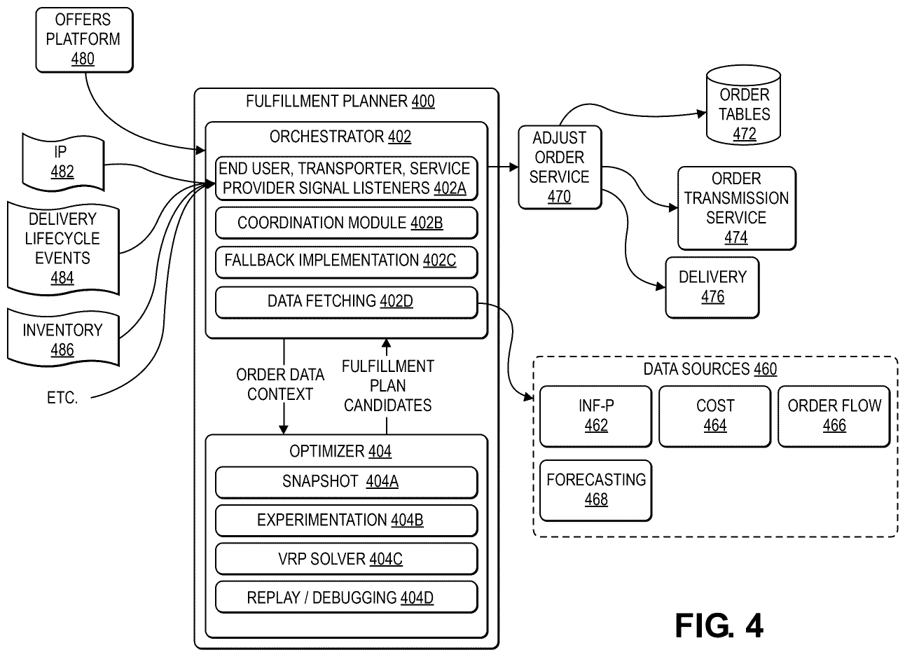

FIG. 4 provides a detailed block diagram of the fulfillment planner 400 according to embodiments, which may be implemented on a central server computer. The fulfillment planner 400 is configured to intelligently formulate, optimize, and execute fulfillment plans for orders. The fulfillment planner 400 comprises two primary, interconnected components: an orchestrator 402 and an optimizer 404.

The orchestrator 402 can listen to inputs such as item discounts and events (e.g., order creation, order update, cancellation), fetch data from data sources 460, and provide it to the optimizer 404 to determine a fulfillment plan. Based on the optimizer 404 calculations, the fulfillment planner 400 may adjust orders (e.g., split the order among two service providers as shown by fulfillment plan B 302 in FIG. 3) and implement a better fulfillment option.

Inputs can include inbound orders, order-specific ETA constraints, inventory availability and out-of-stock likelihood at each location, and end user, transporter, and service provider signals. Outputs from the fulfillment planner can include the given cart's fulfillment plan candidates with their costs (pre-checkout) or the given order's updated fulfillment plan based on changes in underlying facts, such as inventory availability or store closure (post-checkout).

The fulfillment planner 400 may be triggered at different stages of an order. The fulfillment planner 400 can respond to events such as an order creation, order update, scheduled checks for freshness, order cancellation, and order completion. The fulfillment plan can exist throughout the order so that decisions can be taken based on a single source of truth, and the validity of the selected fulfillment plan may be verified after order creation. An initial fulfillment plan may be selected according to the end user's order when it is placed, and stored in a selected fulfillment plan database.

Upon order creation or order update, the orchestrator 402 can cause the generation of alternate fulfillment plans. The orchestrator 402 may additionally schedule routine checks for alternate fulfillment plans according to a fixed interval (CRON job). Alternate fulfillment plans may be stored and updated via a database. If the order is deleted, cancelled, or completed, the orchestrator 402 can cancel the scheduled refresh for alternate fulfillment plans.

The orchestrator 402 can decide when to update the selected fulfillment. For example, the orchestrator 402 may cause the generation or selection of alternate fulfillment plans and determine a more desirable alternate fulfillment plan that can replace the selected fulfillment plan. The orchestrator 402 can also notify an order service (e.g., adjustOrder fulfillment plan with new version) of the new fulfillment plan, and update the selected fulfillment plan database to include the new version. The end user may be notified in various ways.

The orchestrator 402 serves as the central control and state management module for the fulfillment planner 400. It is composed of several sub-modules, including signal listeners 402A, a coordination module 402B, a fallback implementation module 402C, and a data fetching module 402D. The signal listeners 402A are configured to receive a variety of real-time event signals that can trigger the formulation or re-formulation of a fulfillment plan. These input signals originate from several upstream systems, including an offers platform 480 (providing data on user-facing offers), a IP (insights platform) 482 (providing general data and insights platform events, such as cart updates), delivery lifecycle events 484 (providing status updates on in-progress deliveries), and inventory 486 systems (providing data on item stock levels).

Upon receiving a trigger event via the signal listeners 402A, the orchestrator 402, through its data fetching module 402D, gathers the relevant order data context and provides this context as an input to the optimizer 404.

The optimizer 404 acts as the computational engine of the fulfillment planner 400, responsible for generating and evaluating potential fulfillment plans. It takes the order data context from the orchestrator 402 and processes it using a plurality of analytical modules. These modules may include an INF-P (Inventory-Not-Found-Prediction) module 462, which can be implemented using at least one machine learning model and is used to determine the probability of item availability at different resource provider locations. A cost module 464 is used to calculate the estimated fulfillment cost for potential plans. The optimizer 404 also analyzes data related to current order flow 466 and may utilize a VRP (Vehicle Routing Problem) solver 404C and forecasting data 468 to assess factors such as the probability of batching the order with other deliveries. The optimizer 404 is further supported by a suite of platform tools for analysis and development, including modules for creating a snapshot 404A of the system state, conducting experimentation 404B, and performing Replay/Debugging 404D.

After analyzing the data, the optimizer 404 generates and provides one or more fulfillment plan candidates as an output back to the orchestrator 402.

The orchestrator 402 receives these fulfillment plan candidates and, using its coordination module 402B, selects the most optimal plan. In making this selection, the orchestrator 402 may also consult additional data sources 460. Once a final fulfillment plan is selected, the orchestrator 402 executes the plan by sending instructions to the adjust order service 470. This service then propagates the necessary changes to downstream systems, including updating the order tables 472, triggering the order transmission service 474 to communicate with the selected resource provider(s), and initiating the creation or modification of a delivery 476. This architecture enables the fulfillment planner 400 to operate as an intelligent layer that dynamically optimizes how an order is fulfilled based on a comprehensive set of real-time signals and predictive models. Delivery execution can occur as described above.

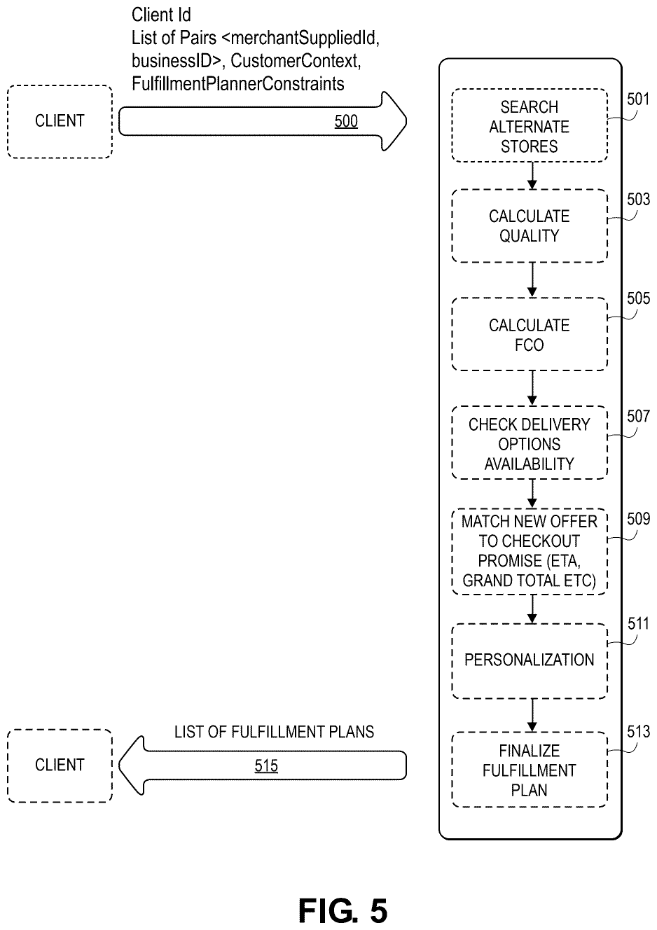

FIG. 5 illustrates a flow diagram of a method 500 for generating and ranking a plurality of fulfillment plans, according to an embodiment. The method 500 may be performed by the optimizer component of the fulfillment planner system, for example, in response to an order event or other trigger as determined by the orchestrator.

The method begins after an order for one or more items is received. At step 501, a set of candidate service providers is determined from a plurality of service providers. This determination can be made by searching for all service providers which are open, are within a predetermined delivery radius of the end user, and whose catalogs contain the one or more items. For example, a search API may be used to identify candidate service providers within a 20 km radius of the end user's location. The set of service provider locations may be under the same service provider (e.g., multiple locations of a single grocery chain) or across different service providers (e.g., a grocery store, a convenience store, and a retail pharmacy).

Once the set of candidate service provider locations is decided, each service provider location in the set is treated as a potential fulfillment plan candidate. Throughout the method, potential service provider locations may be filtered out if they exceed certain cost thresholds or do not meet end user preferences.

At step 503, a probability of availability is determined for the items at each of the service provider locations. This determination may involve checking inventory levels using at least one machine learning model and/or an inventory API. The probabilities that the items are present at the service provider locations are determined using an inventory/INF predictor model. Higher probabilities of item availability are associated with higher quality, and service provider locations with low probabilities of item availability may be filtered out.

In some embodiments, the at least one machine learning model is an inventory-not-found prediction (INF-P) model that outputs a risk score indicating a likelihood that an item is out of stock. The inventory predictor (INF-P) model may be used to determine risk scores that indicate the likelihood that an item will not be available at the service provider locations. The system can then identify which service provider locations are likely to have the items in stock based on the risk scores. If the risk score of an item is above a predetermined threshold, the item may be considered out of stock at that service provider location. For example, if an initial set of twenty candidate service providers is determined at step 501, the system may, at step 503, identify that only fifteen of the twenty service providers are likely to have all items in the order in stock.

A technical objective of the INF-P model is to generate a real-time risk score, typically a probability between 0.0 and 1.0, that quantifies the likelihood of a specific item being physically unavailable on the shelf at a particular service provider location at a given moment. This model can be trained to overcome the discrepancy that often exists between a service provider's digitized inventory records and the actual, on-the-ground reality of stock levels, which are affected by factors such as theft, damage, and replenishment latency.

The training of the INF-P model can be a supervised learning process that relies on the creation of a comprehensive feature set derived from a heterogeneous collection of data sources. To prepare the training data, a large historical dataset of individual item fulfillment attempts is compiled. For each attempt, a high-dimensional feature vector can be constructed using data available up to the point in time of the attempt. These features may include: 1) signals from service provider inventory systems, such as the last reported stock count and the time elapsed since the last inventory update; 2) features extracted from real-time or recent visual data, wherein images of store shelves captured by transporter devices are processed by a computer vision model (e.g., a convolutional neural network) to detect the presence or absence of the specific item, generating features like cv_detected_presence or cv_estimated_stock_count; and 3) historical fulfillment statistics for the specific item-service provider pair, such as its out-of-stock rate over various recent time windows (e.g., the last hour, the last 24 hours), its sales velocity, and its fulfillment rate by time of day and day of week.

The model can be formulated as a binary classification or, more preferably, a probabilistic regression problem. The ground truth labels for training can be derived from the terminal outcomes of the historical fulfillment attempts. An attempt where a transporter successfully retrieves the item can be assigned a label of ‘0’ (in-stock), while an attempt where the transporter explicitly marks the item as unavailable in their device application provides a strong negative label of ‘1’ (out-of-stock). The INF-P model, which may be implemented using an architecture such as a gradient-boosted decision tree (GBDT) or a deep neural network, is then trained on this labeled dataset. The training process involves iteratively optimizing the model's internal parameters to minimize a loss function, such as binary cross-entropy (log loss), which penalizes the model for incorrect probability predictions. Once trained, the model can be deployed to ingest a real-time feature vector for any given item and service provider, and in response, output the predictive risk score that is used by the fulfillment planner to formulate the optimal fulfillment plan.

At step 505, a fulfillment cost is calculated for each of the potential fulfillment plans. This calculated cost may depend on factors such as the straight-line distance from the service provider to the end user, delivery fees, transporter pay, and estimated delivery time. The calculation may also include determining a probability of batching the order with one or more other orders, as improved batching can reduce the overall fulfillment cost.

At step 507, delivery options (e.g., express or standard) are verified. For example, the system can verify that delivery routes are accessible according to current weather and traffic conditions. This can ensure the order is not routed to service providers where delivery may not be possible.

At step 509, pricing and delivery times are verified based on real-time data. The system may verify that an estimated time of arrival is within a specific percentage of an estimate provided to the end user during checkout, thereby reducing potential cancellations.

At step 511, the potential fulfillment plans are further filtered based on end user preferences. For example, if the end user explicitly selected a specific store during checkout, the system may prioritize fulfillment by that checkout store.

At step 513, the remaining fulfillment plan candidates are finalized and ranked. The system can accumulate all previously determined signals and use a scoring or penalty-based system to generate a final ranking. The signals considered may include the fulfillment cost, the INF-P probability (e.g., the probability that an item will be available), the batching probability, and a historical quality hub score, where the hub score is a historical quality score indicating a store's history of cancellations, INF, and inventory availability.

At step 515, the ranked list of fulfillment plans is returned to a calling service, such as the orchestrator.

After the ranked list of fulfillment plans is received, the top-ranked plan may be selected and used to satisfy the fulfillment request. For example, the central server computer can execute the selected fulfillment plan by matching it to one or more available transporters (e.g., a VRP algorithm), who can then pick up and deliver the requested item(s) according to the plan by transmitting instructions to a transporter device.

In some embodiments, executing the fulfillment plan comprises providing a fulfillment request message to the one or more transporter user devices, wherein the one or more transporter user devices determine whether or not to request to accept the fulfillment request message. The server computer receives an acceptance message from a transporter user device of the one or more transporter user devices, and generates an update message indicating a status of the fulfillment request message, and provides the update message to the end user device.

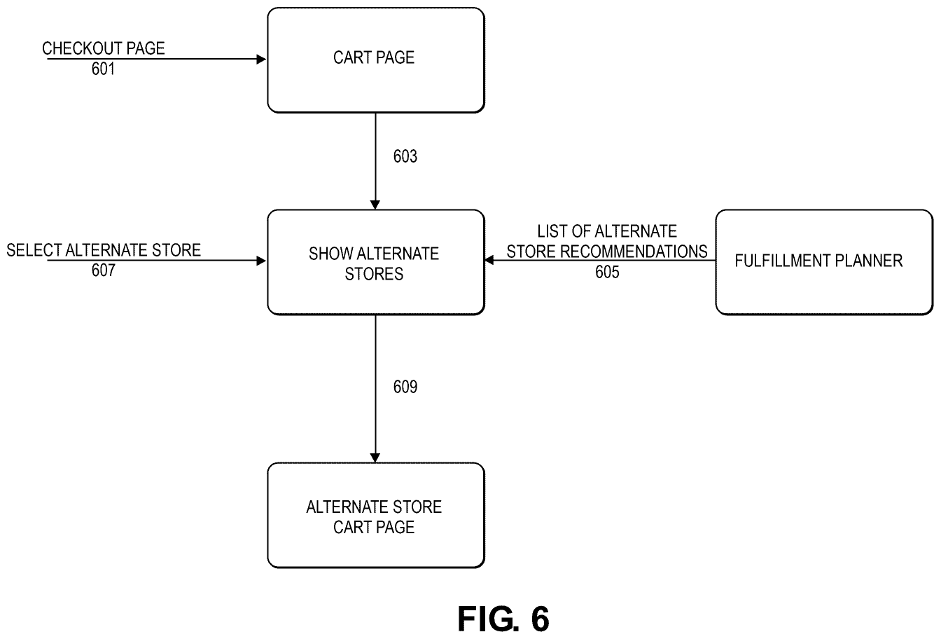

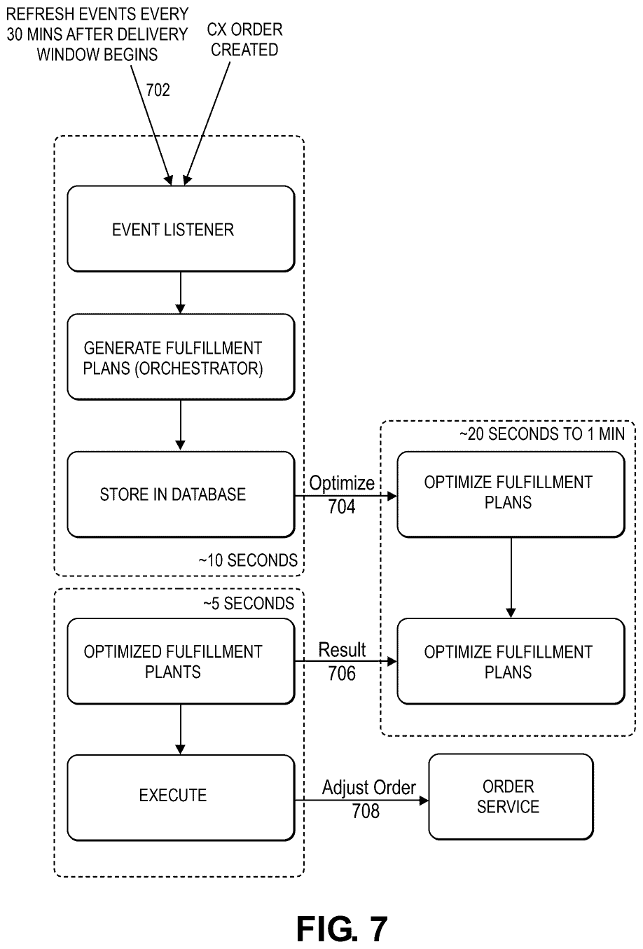

FIGS. 6-7 illustrate flow diagrams of scenarios which may trigger the fulfillment planner. In the scenarios, an end user may operate an end user device to access an item fulfillment service platform provided by a central server computer. The central server computer may comprise a fulfillment planner.

FIG. 6 illustrates a flow diagram of a scenario where an end user created a cart but has not yet placed an order. At 601, the end user creates a provisional cart comprising an item for a specific store X. The end user can proceed to checkout and lands on the checkout page.

At 603, the central server computer determines that the store X cannot fulfill the order with high confidence. For example, the INF model may determine that there is a high risk score for the item at the specific store and it is likely out of stock.

At 605, the central server computer can transmit alternate store options which can fulfill the order with high confidence to the end user. For example, the central server computer can retrieve one or more alternative fulfillment plans from the fulfillment planner which do not have high risk scores for the item, and display them to the end user as selectable offers.

At 607 and 609, the end user can confirm one of the alternate stores and the central server computer can route the end user to a different store page to place their order.

In this example, the end user has browsed the selection of store X and is about to check out. Before, the central server computer would have to accept the end user choice and proceed with checkout and fulfillment. Now, the central server computer can evaluate different options and present alternate stores that have better inventory levels for the items they need.

FIG. 7 illustrates a flow diagram of a scenario where an end user placed an order but it has not yet been presented to a transporter. For example, the order may be a scheduled order for a later time.

Prior to 702, the end user may place the order at a selected store. The fulfillment planner can schedule routine checks for alternate fulfillment plans at predetermined intervals (e.g., every 30 minutes).

At 702, at every interval, the fulfillment planner can refresh alternate fulfillment plans. The fulfillment planner can generate alternate fulfillment plans and store it in a database.

At 704, the fulfillment planner can optimize the alternate fulfillment plans and return a list of ranked fulfillment plans in 706. At 708, if there is a better fulfillment plan than the existing fulfillment plan, the fulfillment planner can update the fulfillment plan with the order service and notify the end user. This process of periodically re-formulating the fulfillment plan allows the system to identify a more optimal fulfillment plan based on changing conditions prior to a scheduled delivery time.

In some embodiments, if item fulfillment failed, the central server computer can initiate a reorder automatically. In this case, the end user can place an order for items at a store, but may later cancel the order. For example, a transporter may not be able to find requested items, or the store can be unexpectedly closed. The central server computer may receive a signal indicating a fulfillment failure.

In embodiments of the invention, the fulfillment planner detects the fulfillment failure and automatically finds alternate store(s). For example, the fulfillment planner can generate and optimize alternate fulfillment plans. For instance, a fulfillment plan can be generated and optimized by selecting at least one new service provider for the fulfillment plan.

The fulfillment planner updates the fulfillment plan to include the alternate store(s). The central server computer can re-present the new fulfillment plan to one or more transporters. The transporter(s) that accepted the fulfillment plan can then fulfill the order according to the updated fulfillment plan. The fulfillment planner may also notify the end user.

Embodiments can also provide a virtual store to combine selections from multiple physical stores into one experience. Item fulfillments need not be constrained to a single physical store.

The virtual store can include the combination of three physical stores with different transmission modes. Instead of browsing across each store individually, the end user can shop across the three stores via the virtual store. The virtual store can show arbitrary combinations of selection to the end user that do not overlap, and defer the choice of fulfillment location until after the checkout process is completed.

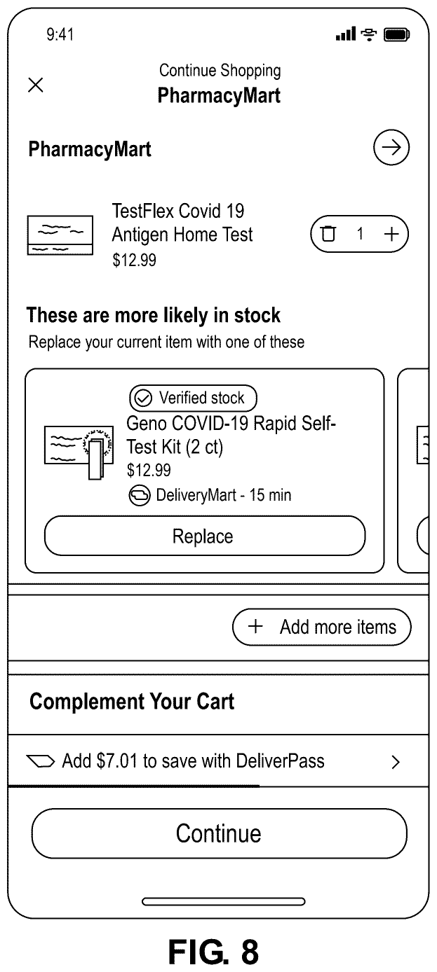

FIG. 8 shows a screenshot of a graphical user interface of that a user may view in embodiments of the invention. The screenshot shows that a Covid test kit may be out of stock at a first service provider. A pop up can then show the end user that a similar Covid test kit may be present at a different service provider and may request that the end user choose the similar Covid test kit as a replacement for the out of stock Covid test kit.

Embodiments of the invention provide a number of technical advantages over conventional fulfillment systems. A technical advantage stems from the two-phase optimization strategy, which separates the problem of service provider selection from the problem of transporter selection/presentment. This approach significantly reduces the computational complexity and cardinality of the fulfillment problem, as compared to a monolithic approach that attempts to simultaneously optimize across items, service providers, and transporters. This efficient, sequential optimization is enabled by the architectural separation of the user-facing order from the underlying fulfillment tasks. This allows the system to dynamically select and adjust the fulfillment plan with substantially less processing time and memory resources, making it feasible to perform complex optimizations in real-time, even at the pre-checkout stage.

A further technical advantage lies in the system's ability to make proactive, data-driven fulfillment decisions rather than merely reacting to fulfillment failures. By utilizing predictive machine learning models to determine the real-time probability of item availability at various service provider locations, the system can anticipate and mitigate potential issues, such as out-of-stock items before a transporter is even dispatched. The event-driven nature of the fulfillment planner allows it to continuously ingest signals from across the network and re-evaluate fulfillment plans in response to changing conditions. This results in a more resilient and efficient fulfillment process, leading to technically superior outcomes such as higher order completion rates, reduced fulfillment costs through optimized batching, and an improved end-user experience.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

As used herein, the use of “a,” “an,” or “the” is intended to mean “at least one,” unless specifically indicated to the contrary.

What is claimed is:

1. A method comprising:
receiving, from an end user device, an order for one or more items, wherein the one or more items are available from a plurality of service providers at a plurality of service provider locations;
determining a set of candidate service providers from the plurality of service providers, wherein each candidate service provider is within a predetermined distance of a user location associated with the order;
for each candidate service provider in the set of candidate service providers, determining, using at least one machine learning model, a probability of availability for the one or more items at the respective service provider location;
formulating a fulfillment plan by selecting one or more service providers from the set of candidate service providers based at least in part on the determined probabilities of availability; and
executing the fulfillment plan.

2. The method of claim 1, wherein executing the fulfillment plan further comprises:
providing a fulfillment request message to the one or more transporter user devices, wherein the one or more transporter user devices determine whether or not to request to accept the fulfillment request message;
receiving an acceptance message from a transporter user device of the one or more transporter user devices;
generating an update message indicating a status of the fulfillment request message; and
providing the update message to the end user device.

3. The method of claim 2, wherein the fulfillment plan involves obtaining two or more items from two or more service providers, and wherein a first service provider order is transmitted to a first service provider and a second service provider order is transmitted to a second service provider.

4. The method of claim 3, wherein the two or more items are food items.

5. The method of claim 1, wherein the order is a provisional cart, and wherein the method further comprises:
generating one or more alternative fulfillment plans; and
providing the one or more alternative fulfillment plans to the end user device as selectable offers prior to checkout.

6. The method of claim 1, wherein formulating the fulfillment plan is further based on a determined probability of batching the order with one or more other orders.

7. The method of claim 1, wherein the at least one machine learning model is an inventory-not-found prediction model that outputs a risk score indicating a likelihood that an item is out of stock.

8. The method of claim 1, further comprising, for a scheduled order, periodically re-formulating the fulfillment plan at a predetermined time interval prior to a scheduled delivery time to identify a more optimal fulfillment plan.

9. The method of claim 1, wherein the order is received from a virtual store interface that presents a combined inventory from a plurality of distinct physical service provider locations.

10. The method of claim 1, wherein the fulfillment plan is also formulated by selecting one or more service providers from the set of candidate service providers based on a calculated fulfillment cost.

11. The method of claim 1, wherein formulating the fulfillment plan is further based on a historical quality score associated with each candidate service provider.

12. A central server computer comprising:
a processor; and
a computer readable medium coupled to the processor, the computer readable medium comprising code, executable by the processor to perform a method comprising:
receiving, from an end user device, an order for one or more items, wherein the one or more items are available from a plurality of service providers at a plurality of service provider locations;
determining a set of candidate service providers from the plurality of service providers, wherein each candidate service provider is within a predetermined distance of a user location associated with the order;
for each candidate service provider in the set of candidate service providers, determining, using at least one machine learning model, a probability of availability for the one or more items at the respective service provider location;
formulating a fulfillment plan by selecting one or more service providers from the set of candidate service providers based at least in part on the determined probabilities of availability; and
executing the fulfillment plan.

13. The central server computer of claim 12, wherein executing the fulfillment plan further comprises:
providing a fulfillment request message to the one or more transporter user devices, wherein the one or more transporter user devices determine whether or not to request to accept the fulfillment request message;
receiving an acceptance message from a transporter user device of the one or more transporter user devices;
generating an update message indicating a status of the fulfillment request message; and
providing the update message to the end user device.

14. The central server computer of claim 13, wherein the fulfillment plan selects two or more service providers to supply different items in the fulfillment plan, and wherein a first service provider order is transmitted to a first service provider and a second service provider order is transmitted to a second service provider.

15. The central server computer of claim 12, wherein the fulfillment plan selects two or more service providers to supply different items in the fulfillment plan.

16. The central server computer of claim 12, wherein the order is a provisional cart, and wherein the method further comprises:
generating one or more alternative fulfillment plans; and
providing the one or more alternative fulfillment plans to the end user device as selectable offers prior to checkout.

17. The central server computer of claim 12, wherein formulating the fulfillment plan is further based on a determined probability of batching the order with one or more other orders.

18. The central server computer of claim 12, wherein the at least one machine learning model is an inventory-not-found prediction model that outputs a risk score indicating a likelihood that an item is out of stock.

19. The central server computer of claim 12, wherein the order is a scheduled order, and wherein the method further comprises:
periodically re-formulating the fulfillment plan at a predetermined time interval prior to a scheduled delivery time to identify a more optimal fulfillment plan.

20. The central server computer of claim 12, wherein formulating the fulfillment plan is further based on a historical quality score associated with each candidate service provider.
